(19) United States
(12) Patent Application Publication
(10) Pub. No.: US 2026/0279713 A1
(43) Pub. Date: Sep. 17, 2026

(54) SWITCHING DEVICE

(71) Applicant: TDK Electronics AG, Muenchen (DE)

(72) Inventors: Robert Hoffmann, Berlin (DE); Robert Minkwitz, Berlin (DE)

(21) Appl. No.: 19/469,849

(22) PCT Filed: Apr. 3, 2024
(86) PCT No.: PCT/EP2024/058998

§ 371 Date: Sep. 26, 2025

(30) Foreign Application Priority Data
Apr. 6, 2023 (DE) 10 2023 108 928.5

(51) Int. Cl. H01H 50/56; H01H 50/18; H01H 50/54

(52) U.S. Cl. CPC H01H 50/56; H01H 50/18; H01H 50/546

(57) ABSTRACT

In an embodiment a switching device includes a movable contact in a switching chamber and at least two auxiliary contacts, two spring contacts and a contact plate in the switching chamber, wherein the switching chamber has side wall parts, wherein each of the spring contacts includes a first contact region and a second contact region, wherein the first contact region and the second contact region are connected via a connection region, wherein a side wall part is arranged between the connection region of each of the spring contacts and the movable contact, and wherein the contact plate is movable together with the movable contact.

### CROSS-REFERENCE TO RELATED APPLICATIONS

This patent application is a national phase filing under section 371 of PCT/EP2024/058998, filed Apr. 3, 2024, which claims the priority of German patent application no. 102023108928.5, filed Apr. 6, 2023, each of which is incorporated herein by reference in its entirety.

### TECHNICAL FIELD

A switching device is specified.

The switching device is configured in particular as an electromagnetically operated, remote-controlled switch that can be operated by an electrically conductive current. The switching device can be activated via a control circuit and can switch a load circuit. In particular, the switching device can be configured as a relay or as a contactor, in particular as a power contactor. The switching device can be configured as a gas-filled power contactor.

One possible application of such switching devices, in particular of power contactors, is the opening and disconnecting of battery circuits, for example in motor vehicles such as electrically or partially electrically operated motor vehicles or in applications in the field of renewable energies.

### BACKGROUND

In its function as a safety component, a contactor is normally monitored additionally, wherein contactor monitoring is regulated in the IEC 60947-5-1 standard. Contactor monitoring is intended, for example, to detect the most common fault in contactors, relays, and switches, namely sticking or welding of the main contacts. Such a fault, also known as contactor sticking, can be caused, for example, by arcing that forms between the contacts during switching operations under load, which can cause high temperatures on the contact surfaces that weld the contact surfaces together. It is also advantageous if other fault conditions can be detected, for example if a contact is mechanically blocked in an open position or in an intermediate state.

Typical contactors are configured as so-called overtravel systems. This means that after the main contacts have been interconnected by the switching bridge and thus electrically closed, the movement of the closing system is continued, wherein a usually spring-loaded pressure of the switching bridge on the main contacts increases. In the event of a contactor sticking, this overtravel is reduced again, but the switching bridge remains stuck to at least one main contact. The mechanical system is thus stuck in an intermediate state and is neither open nor properly closed.

Monitoring or contactor sticking detection can be carried out, for example, by measuring the voltage across the main contacts of the contactor. If there is voltage between the main contacts, the contactor is open. If there is no voltage, it follows that the contactor is short-circuited and therefore closed. Although this method is very safe, it is also expensive to implement, as cables carrying high voltages must be laid and insulated accordingly. Monitoring is usually carried out by a higher-level system, such as a microcontroller-controlled AD converter.

It is also known, for example, to use a microswitch in the switching chamber of the contactor, which is operated by a small lever on the switching bridge. The lever actuates the switch shortly before the switching bridge is pressed against the main contacts. The switch can be configured as a normally open contact (closed when pressed) or as a normally closed contact (open when pressed). The signal from the microswitch can thus also be configured to be inverted in relation to the switching state of the contactor. A disadvantage of this solution is that the microswitch must be mounted close to the main contacts within the switching chamber. This can sometimes influence arc extinction or result in insulation disadvantages. Furthermore, the monitoring contact formed by the lever and microswitch must be configured to be advance-acting. This means that the monitoring contact changes its state before the main contact closes. This is because the microswitch must still indicate the “closed” state when the overtravel has already been used up in the event of sticking. Intermediate states or blockages cannot be detected as a result. Another disadvantage is the service life of conventional microswitches, which can be only a few hundred thousand switching cycles, depending on the design. Furthermore, supply lines must be laid to the switch, which limits the use of completely hermetically sealed ceramic discharge chambers.

Furthermore, for example, the publication WO 2008/033349 A2 discloses an auxiliary switch which is operated via an arm on the switching bridge, wherein, for example, two overlapping contacts can be pressed together. Although this solution is simple, inexpensive, and virtually wear-free, it has the disadvantage that the overlapping contacts are located between the main contacts, which can lead to insulation problems. However, it has the disadvantage that the overlapping contacts are located between the main contacts, which can lead to insulation problems. Furthermore, supply lines must be laid to the auxiliary switch, which limits or prevents the use of completely hermetically sealed ceramic discharge chambers. The switching behavior is still similar to that of the microswitch.

In order to circumvent the disadvantages described, it is also known to attach a magnet to the lower part of the movable system, and in particular outside the switching chamber, which can open and close a reed switch, as described, for example, in JP 2013-008621 A. This means that detection takes place far away from the main contacts and can also be carried out through non-magnetic materials. In addition, this solution is easy to use in conjunction with hermetically sealed ceramic discharge chambers. The switching behavior is analogous to the two systems described above, but the difficulty of setting the overlap region correctly arises because the indication is magnetic and hysteresis effects must also be taken into account. Another disadvantage is the sensitivity of the reed switch to magnetic interference fields and mechanical shocks.

To improve this, it is known to use a Hall sensor instead of the reed switch, so that magnetic detection is not performed by a mechanical switch but by a semiconductor component. As a result, magnetic interference fields no longer play a role and there is no longer any vibration dependence. However, the switching behavior is similar to that of the reed switch.

All four monitoring switch solutions have a so-called “normally open” characteristic, i.e., the monitoring switch largely reflects the state of the main contacts. However, inversion of the signal does not produce a “normally closed” state, but only a “not normally open” state. All four principles have in common that none of these solutions can reliably signal that the monitored contactor is safely and completely open. However, such a requirement is specified in the IEC 60947-5-1 standard, which requires detection that, only when the contactor is in the rest state, closes a monitoring contact or indicates a closed monitoring contact (“normally closed”).

Furthermore, the known solutions usually cannot be converted from a “normally open” characteristic to a “normally closed” characteristic, or only with considerable design effort.

### SUMMARY

Embodiments provide a switching device.

According to at least one embodiment, a switching device has at least one fixed contact and at least one movable contact. The at least one fixed contact and the at least one movable contact are intended and configured to switch on and off a load circuit connectable to the switching device. In particular, the switching device has at least two fixed contacts which, together with the movable contact, are intended and configured to switch on and off a load circuit connectable to the switching device and, in particular, to the at least two fixed contacts. In the following, the switching device is mostly described with at least one fixed contact or with two fixed contacts. However, the number of fixed contacts can differ from the numbers specifically mentioned in the following embodiments and in relation to the features described below.

The movable contact is movable in the switching device between a non-conducting state and a conducting state of the switching device in such a way that, in the non-conducting state of the switching device, the movable contact is spaced apart from the fixed contacts and is thus galvanically separated from them, and in the conducting state, it has a mechanical contact with the at least two fixed contacts and is thus galvanically connected to them. The fixed contacts are thus arranged separately from one another in the switching device and, depending on the state of the movable contact, can be electrically conductively connected to one another or electrically separated from one another by the movable contact. In the switching state, the movable contact thus contacts, with at least one contact surface, at least one contact surface of at least one fixed contact. The distance between the movable contact, in particular the said movable contact surface of the movable contact, and the at least one fixed contact, in particular the said contact surface of the at least one fixed contact, in the non-conducting and thus separated state is referred to here and in the following as the switching gap and indicates the maximum movement range and thus the maximum achievable distance between the contacts and in particular their contact surfaces. In the case of, for example, two fixed contacts, the previous description applies accordingly.

According to a further embodiment, the switching device has a switching chamber in which the movable contact and the fixed contacts are arranged. The movable contact can, in particular, be arranged completely in the switching chamber. The fact that a fixed contact is arranged in the switching chamber can, in particular, mean that at least one contact region of the fixed contact, which is in mechanical contact with the movable contact in the switching state, is arranged within the switching chamber. For connecting a supply line of a circuit to be switched by the switching device, a fixed contact arranged in the switching chamber can be electrically contactable from the outside, i.e., from outside the switching chamber. For this purpose, a fixed contact arranged in the switching chamber can protrude from the switching chamber with a part and have a connection possibility for a supply line outside the switching chamber. The switching chamber thus preferably has openings through which the fixed contacts protrude into the switching chamber. The fixed contacts are, for example, soldered into the openings of the switching chamber and protrude both in a direction parallel to the axis of the switching chamber into the interior of the switching chamber and out of the switching chamber.

According to a further embodiment, the switching device has at least two auxiliary contacts which are arranged in the switching chamber. The fact that an auxiliary contact is arranged in the switching chamber can in particular mean that at least one contact region of the auxiliary contact is arranged within the switching chamber. For connecting a supply line, an auxiliary contact arranged in the switching chamber can be electrically contactable from the outside, i.e., from outside the switching chamber. For this purpose, an auxiliary contact arranged in the switching chamber can protrude from the switching chamber with a part and have a connection possibility for a supply line outside the switching chamber. The switching chamber thus preferably has openings through which the auxiliary contacts protrude into the switching chamber. The auxiliary contacts are, for example, soldered into the openings of the switching chamber and protrude both into the interior of the switching chamber and out of the switching chamber. The auxiliary contacts can thus be lead into the switching chamber by means of a hermetically sealed and, for example, brazed connection comparable to the feed-through of the fixed contacts, which can preferably be carried out in a common manufacturing step and thus in a common work operation.

According to a further embodiment, the switching device has at least two spring contacts which are arranged in the switching chamber. Furthermore, the switching device has a contact plate which is arranged in the switching chamber. In particular, the spring contacts and the contact plate are arranged completely within the switching chamber. Each of the spring contacts has at least a first and a second contact region. Each of the spring contacts can contact one of the auxiliary contacts with the first contact region. In particular, each of the spring contacts can contact one of the auxiliary contacts permanently and independently of the switching states of the switching device during normal operation with its first contact region. The first contact region of a spring contact can in particular bear directly and thus mechanically against an auxiliary contact.

According to a further embodiment, the contact plate is movable together with the movable contact. In a particularly preferred embodiment, the contact plate and the movable contact can be moved together by means of a single mechanical drive, which is described in more detail below. For example, in a first switching state of the switching device, the contact plate contacts the second contact regions of the spring contacts and, in a second switching state, is spaced apart from the second contact regions of the spring contacts. In the first switching state, the auxiliary contacts are thus short-circuited via the spring contacts and the contact plate, while in the second switching state the auxiliary contacts are electrically separated from one another. For example, by detecting the electrical resistance between the auxiliary contacts, it can be determined whether the switching device is in the first or second switching state.

The first switching state can, for example, be the non-conducting switching state of the switching device described above, which can correspond to a rest state of the switching device, while the second switching state can be the conducting switching state described above. In other words, the contact plate can contact the second contact regions of the spring contacts when the movable contact is spaced apart from the at least one fixed contact, while the contact plate is spaced apart from the second contact regions of the spring contacts when the movable contact of the switching device contacts the at least one fixed contact. In this case, the auxiliary contacts with the spring contacts and the contact plate can have a “normally closed” characteristic that is opposite to the switching state of the switching device.

Furthermore, it can also be possible that the first switching state is the conducting state, while the second switching state is the non-conducting state. In this case, the function of the detection of a state of the switching device made possible by the auxiliary contacts is reversed with a “normally open” characteristic, so that in this case the contact plate contacts the second contact regions of the spring contacts when the movable contact contacts the at least one fixed contact, while the contact plate is spaced apart from the second contact regions of the spring contacts when the movable contact of the switching device is spaced apart from the at least one fixed contact.

According to a further embodiment, the switching device has a housing in which the movable contact, the fixed contacts, the auxiliary contacts, the spring contacts and the contact plate are arranged. The fact that a fixed contact is arranged in the housing can mean in particular that at least one contact region of the fixed contact, which is in mechanical contact with the movable contact in the switching state, is arranged inside the housing. For connecting a supply line of a circuit to be switched by the switching device, a fixed contact arranged in the housing can be electrically contactable from the outside, i.e., from outside the housing. For this purpose, a fixed contact arranged in the housing can protrude from the housing with a part and have a connection possibility for a supply line outside the housing. In particular, this can apply to each fixed switching contact. The movable contact can in particular be arranged completely within the housing. Furthermore, the auxiliary contacts can also be arranged completely within the housing. The auxiliary contacts can be contacted from the outside via supply lines within the housing which are electrically conductively connected, for example, to external electrical connections on the housing. Alternatively, an electrical component such as a microcontroller can be provided in the housing, which is connected to the auxiliary contacts via electrical supply lines. The microcontroller can in turn be accessible from the outside via suitable connections on the housing.

According to a further embodiment, the contacts are arranged in a gas atmosphere in the housing. This can mean, in particular, that the movable contact, the spring contacts and the contact plate are arranged completely in the gas atmosphere in the housing and that, furthermore, at least parts of the fixed contacts, such as the contact regions of the fixed contacts, and at least parts of the auxiliary contacts, such as contact regions of the auxiliary contacts, are arranged in the gas atmosphere in the housing. The switching device can preferably be a gas-filled switching device such as a gas-filled contactor. The gas atmosphere can in particular promote the extinguishing of arcs that can arise during the switching operations. The gas of the gas atmosphere may, for example, comprise or be a gas containing hydrogen and/or nitrogen, in particular under high pressure. Preferably, the gas can comprise at least 50% H₂. In addition to hydrogen, the gas can comprise an inert gas, particularly preferably N₂ and/or one or more noble gases.

According to a further embodiment, the switching chamber is located inside the housing. Furthermore, the gas, i.e. at least part of the gas atmosphere, can be located in the switching chamber.

According to a further embodiment, the movable contact and the contact plate are movable by means of a mechanical drive. The mechanical drive has, in particular, a magnetic armature. The magnetic armature can have a shaft which is connected at one end to the movable contact and the contact plate in such a way that the movable contact and the contact plate are movable by means of the shaft, i.e. they are also moved by the shaft when the shaft moves. The shaft can in particular project into the switching chamber through an opening in the switching chamber. In particular, the switching chamber can have a switching chamber base which has an opening through which the shaft projects. The magnetic armature can be movable by a magnetic circuit in order to effect the switching operations described above. For this purpose, the magnetic circuit can have a yoke which has an opening through which the shaft of the magnetic armature protrudes. When the magnetic circuit is switched on, the magnetic armature, in particular a magnetic core of the magnetic armature, can be pulled toward the yoke.

According to a further embodiment, the movable contact and the contact plate are arranged on an electrically insulating contact holder. The contact holder can be arranged and fastened on the shaft of the magnetic armature and electrically insulate the movable contact and the contact plate from the shaft. This allows the movable contact and the contact plate to be electrically insulated from the components of the mechanical drive, in particular from the components of the magnetic armature. The contact holder can comprise or be made of an electrically insulating material. The electrically insulating material can be selected from polymers and ceramic materials, for example selected from polyoxymethylene (POM), in particular with the structure (CH₂O)ₙ, polybutylene terephthalate (PBT), glass fiber-filled PBT, and electrically insulating metal oxides such as Al₂O₃.

According to a further embodiment, the contact plate is fixed to the contact holder. The fixing can be effected, for example, by means of a clamp. It is particularly preferred that the contact plate is partially formed from the material of the contact holder. For this purpose, the contact plate can be cast or injection molded with the material of the contact holder, for example. Contact regions of the contact plate can protrude from the contact holder to make contact with the second contact regions of the spring contacts.

During a switching operation, the magnetic armature, the shaft, the movable contact and the contact plate preferably move in a linear movement in the form of a lifting or lowering movement along the shaft. Preferably, the shaft and, for example, a magnetic core of the magnetic armature have a vertical movement range for the stroke movement that is greater than the switching gap described above. This can be achieved, for example, by ensuring that, in the switched-off state, a gap between the magnetic core and the yoke, which can also be referred to as the movement gap, is greater than the switching gap. The magnetic armature with the movable contact can thus be an overtravel system in which the movable contact is arranged so as to be displaceable on the contact holder. Furthermore, a contact spring can be arranged on the contact holder, which exerts a spring force on the movable contact in the direction of the fixed contacts. When the movable contact strikes the fixed contacts and thus completely closes the switching gap, the contact spring can deflect and the magnetic armature can continue to move until, for example, the magnetic core rests against the yoke. For example, the movement gap can be smaller than or equal to 1 mm and, particularly preferably, approximately 0.5 mm larger than the switching gap. The difference between the movement gap and the switching gap can be referred to as the overtravel. The deflection of the contact spring by the overtravel increases the contact pressure of the movable contact on the fixed contacts and a certain insensitivity to vibrations and mechanical shocks can be achieved.

The described configuration of the mechanical drive and the switching chamber ensures that the auxiliary contacts, the spring contacts and the contact plate are electrically insulated from the fixed contacts, the movable contact and the mechanical drive. In particular, permanent insulation can be achieved, i.e., insulation that is guaranteed throughout the normal operation of the switching device and thus during the first and second switching states as well as during the transitions between them.

At least one of the contact regions of each of the spring contacts can be spring-loaded. For example, the first contact region of each spring contact can be spring-loaded and exert a spring force on an auxiliary contact. In other words, a first contact region can press against an auxiliary contact when installed and thus exert the spring force. Alternatively or preferably additionally, the second spring regions can be spring-loaded. It is particularly preferred that the second contact regions exert a spring force on the contact plate in the first switching state. The spring force of the second contact regions can be lower than the spring force of the contact spring. The spring action of the second contact regions increases the resistance of the mechanical contact between the contact plate and the second contact regions of the spring contacts to vibrations and mechanical shocks. For example, the spring force of the second contact regions on the contact plate and thus the counterpressure on the magnetic armature and in particular on the contact holder can be less than the return spring force, which has a return spring of the mechanical drive and, in the case of a spring-loaded contact, can move the magnetic armature from the conducting state to the non-conducting state. In particular, the spring force of the second contact regions on the contact plate can be less than or equal to 20% of the return spring force. It is particularly preferred that the spring force of the second contact regions on the contact plate is less than or equal to 20% of the return spring force.

When the switching device transitions from the first to the second switching state, the contact plate can lose mechanical contact with the second contact regions of the spring contacts after traveling a distance that is less than or equal to 20% and preferably less than or equal to 10% of the switching gap. This ensures that the distance traveled by the magnetic armature before the contact between the contact plate and the spring contacts is broken is very small. As described above, the movable contact can, for example, be separated from the fixed contacts by the switching gap in the first switching state, while the contact plate mechanically contacts the second contact regions of the spring contacts. The first switching state can thus be a rest state of the switching device and thus a non-conducting state. Due to the short distance described above, it can be achieved that the absence of the rest state can be detected very reliably at the auxiliary contacts. Furthermore, as described above, the movable contact can be in mechanical contact with the at least one fixed contact in the first switching state. The first switching state can thus be a conducting state of the switching device. When the switching device transitions from the first to the second switching state, the contact plate can lose mechanical contact with the second contact regions of the spring contacts after traveling a distance greater than the overtravel. This ensures that the contact plate remains in mechanical contact with the spring contacts even if the movable contact remains in mechanical contact with at least one fixed contact, for example due to unwanted welding, even if the movable contact and thus the switching device should actually transition to the rest state. In this case, the welding would only reduce the overtravel and the movable contact would remain in the switched state, which could be detected by the auxiliary contacts still short-circuited by the contact plate.

The direction of movement of the movable contact, which corresponds to the main direction of extension of the shaft, i.e. the direction of the upward and downward movement of the movable contact, can also be referred to here and in the following as the vertical direction. The fixed contacts are arranged next to each other along a longitudinal direction, wherein the longitudinal direction lies in a horizontal plane perpendicular to the vertical direction. The movable contact can, for example, be plate-shaped and have a main extension plane parallel to the horizontal plane. A transversal direction is defined perpendicular to the vertical and longitudinal directions, so that the horizontal plane is spanned by the longitudinal and transversal directions. The auxiliary contacts are preferably arranged along the transversal direction, wherein the movable contact can be arranged in particular along the transversal direction between the auxiliary contacts.

According to a further embodiment, the switching chamber has a switching chamber wall. In a horizontal sectional view, i.e. in a sectional view with a sectional plane perpendicular to the vertical direction, the switching chamber wall preferably has a rectangular cross-sectional shape or at least a cross-sectional shape approximating a rectangle. In particular, the switching chamber wall can have opposite longitudinal side wall parts and opposite transversal side wall parts which, in a horizontal sectional view, have a rectangular shape with regard to their outer contours and/or inner contours. In other words, a longitudinal side wall part can extend essentially in the vertical and longitudinal directions, while a transversal side part can extend essentially in the vertical and transversal directions. Preferably, the longitudinal side wall parts, the transversal side wall parts and a cover part with openings for the fixed contacts and openings for the auxiliary contacts can be formed in one piece and form the switching chamber wall.

According to a further embodiment, the switching chamber has a switching chamber base which, together with the switching chamber wall, forms the switching chamber. The switching chamber base can have a base plate and side wall parts, wherein the side wall parts of the switching chamber base can be formed in one piece with the base plate of the switching chamber base. The side wall parts of the switching chamber base can be surrounded in the assembled switching chamber by the side wall parts of the switching chamber wall so that the side wall parts of the switching chamber base can form an insert into the switching chamber wall. At least a part of the side wall parts of the switching chamber base can be spaced apart from side wall parts of the switching chamber wall.

According to a further embodiment, each of the spring contacts has a connection region between the first and second contact regions, which runs along a longitudinal side wall portion of the switching chamber wall. The first and second contact regions of each of the spring contacts can preferably extend from the respective longitudinal side wall portion at least along a transversal direction into the interior of the switching chamber. In particular, the connection region of each of the spring contacts can be arranged behind a side wall portion of the switching chamber base, as viewed from the movable contact in the transversal direction, so that a side wall portion of the switching chamber base is arranged between the movable contact and the connection region of the spring contact for each spring contact. The connection region of each of the spring contacts can thus preferably be arranged in the transversal direction between a side wall part of the switching chamber wall and a side wall part of the switching chamber base.

According to a further embodiment, the switching chamber base has an opening for each spring contact in the side wall part, through which the second contact region of the spring contact can protrude through the side wall part of the switching chamber base. In particular, for each spring contact, the second contact region can protrude along the transversal direction through an opening in a side wall part towards the movable contact and in particular towards the contact plate.

According to a further embodiment, each of the spring contacts in the connection region has at least one opening through which a fastening element of the respective side wall part of the switching chamber base protrudes. The fastening elements are preferably formed in one piece with the respective side wall part and serve to fasten the respective spring contact. For example, the fastening elements can be configured in the form of pins and enable rivet-like fastening.

According to a further embodiment, the switching chamber base has an insertion region in the transversal direction between the movable contact and each of the spring contacts, in which a permanent magnet, in particular a so-called blow magnet, is arranged. Part of the insertion region can preferably be formed by at least part of a side wall part of the switching chamber base. In particular, the side wall part can be the one to which the respective spring contact is fastened. In particular, each of the permanent magnets can be fastened in the insertion region by a snap mechanism. The switching chamber base can thus preferably have two insertion regions between which the movable contact is arranged in the transversal direction. The movable contact can preferably move in the vertical direction along the insertion regions during the transition from the first to the second switching state and vice versa.

According to a further embodiment, the switching chamber wall has at least two webs, each of which is arranged in the longitudinal direction between the at least two fixed contacts and of which at least one extends transversally into the switching chamber from at least one longitudinal side wall part. The webs are spaced apart from each other in the longitudinal direction. In particular, both webs can extend in the transversal direction across the movable contact in the interior of the switching chamber from one of the longitudinal side wall parts to the other of the longitudinal side wall parts. Here, the at least two webs can each have a recess in which the movable contact can move during the switching operations. Furthermore, the webs can be connected directly to a cover part of the switching chamber. In particular, the webs can run along and directly adjacent to a cover part of the switching chamber wall. The webs can be formed in one piece with the side wall parts and/or a cover part of the switching chamber wall.

The at least two webs can be used to form one or more spaces between the fixed contacts in the interior of the switching chamber, which are at least partially separated from the fixed contacts and thus electrically insulated. The auxiliary contacts and the spring contacts can be arranged in particular in the at least one insulated space formed in this way and thus in the longitudinal direction between the two webs. The auxiliary contacts can be arranged symmetrically between the two webs, i.e. symmetrically to a plane of symmetry defined by the longitudinal and vertical directions, which is particularly preferred. Furthermore, the spring contacts can be arranged symmetrically to the movable contact between the two webs. Due to the fact that at least one of the webs is formed between each of the auxiliary contacts and the fixed contacts and between each of the spring contacts and the fixed contacts, the auxiliary contacts and the spring contacts can be at least partially insulated from the fixed contacts. In addition, the insertion regions of the switching chamber base and thus also the permanent magnets can be arranged between the two webs. Furthermore, additional components can be arranged in the insulated space thus formed, such as a gas filling nozzle for filling the gas described above to form the gas atmosphere in the switching chamber.

According to a further embodiment, the insertion regions of the switching chamber base have wall parts which, viewed in the longitudinal direction, are arranged between the webs of the switching chamber wall and between which the permanent magnets are arranged. In particular, the wall parts of the insertion regions can be arranged inserted between the webs and form an intermediate space in which the permanent magnets are arranged. Furthermore, the contact regions of the contact plate can be arranged in this intermediate space and move within the intermediate space when switching from the first to the second switching operation and vice versa. The wall parts of the switching chamber base allow the at least one insulated space described above to be formed together with the webs.

According to a further embodiment, the auxiliary contacts and/or the spring contacts and/or the contact plate comprise a material containing copper or a copper alloy. The material can be selected in particular from CuBe, CuSn₄, CuSn₆. Such a material can have good electrical conductivity and a low tendency to weld. Furthermore, the auxiliary contacts may, for example, comprise the same material as the fixed contacts.

### BRIEF DESCRIPTION OF THE DRAWINGS

Further advantages, advantageous embodiments, and further developments result from the embodiments described below in connection with the figures.

FIG. 1 shows a schematic illustration of a switching device;

FIGS. 2A to 2D show schematic illustrations of parts of a switching device according to an embodiment;

FIGS. 2E and 2F show schematic illustrations of a contact plate and a spring contact of the switching device according to further embodiments;

FIGS. 2G to 2I show schematic illustrations of the switching chamber wall of the switching device according to a further embodiment;

FIGS. 2J to 2M show schematic illustrations of a switching chamber base of the switching device according to a further embodiment; and

FIGS. 3A and 3B show schematic illustrations of parts of a switching device according to a further embodiment.

In the embodiments and figures, identical, similar, or similarly functioning elements can be assigned the same reference sign. The elements shown and their relative sizes are not to be regarded as true to scale; rather, individual elements, such as layers, components, structural elements, and regions, can be shown enlarged for clarity and/or better understanding.

### DETAILED DESCRIPTION OF ILLUSTRATIVE EMBODIMENTS

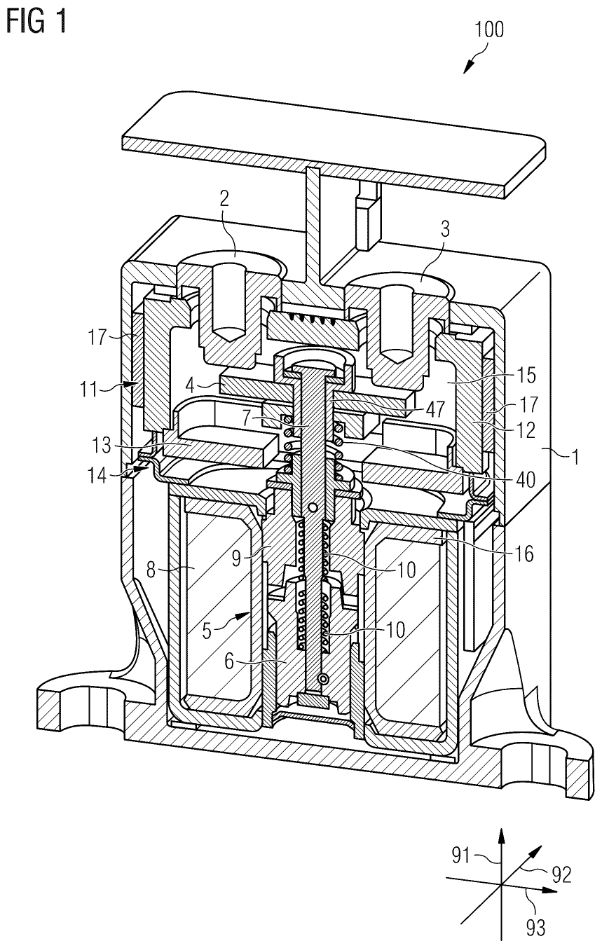

FIG. 1 shows an example of a switching device 100 which can be used, for example, to switch strong electrical currents and/or high electrical voltages and which can be a relay or contactor, in particular a power contactor. FIG. 1 shows a three-dimensional sectional view with a vertical sectional plane. The geometries shown are only to be understood as examples and not as limiting and can also be configured differently.

The exemplary switching device 100 has two fixed contacts 2, 3 and a movable contact 4 in a housing 1. The movable contact 4 is configured as a contact plate. The fixed contacts 2, 3 together with the movable contact 4 form the switching contacts. As an alternative to the number of contacts shown, other numbers of fixed and/or movable contacts are also possible. The housing 1 primarily serves as contact protection for the components arranged inside and has a plastic material or is made of such a material, for example PBT or glass fiber-filled PBT. The fixed contacts 2, 3 and/or the movable contact 4 can, for example, be made with or of Cu, a Cu alloy, one or more high-melting metals such as Wo, Ni and/or Cr, or a mixture of the aforementioned materials, for example of copper with at least one other metal, for example Wo, Ni and/or Cr.

FIG. 1 shows the switching device 100 in a rest state in which the movable contact 4 is spaced apart from the fixed contacts 2, 3 so that the switching contacts 2, 3, 4 are galvanically separated from one another. The design of the switching contacts shown, and in particular their geometry, are purely examples and are not to be understood as limiting. Alternatively, the switching contacts can also be configured differently.

The switching device 100 has a mechanical drive with a movable magnetic armature 5, which essentially performs the switching movement. The magnetic armature 5 has a magnetic core 6, for example with or made of a ferromagnetic material. Furthermore, the magnetic armature 5 has a shaft 7 which is guided through the magnetic core 6 and is firmly connected to the magnetic core 6 at one end of the shaft. At the other end of the shaft opposite the magnetic core 6, the magnetic armature 5 has the movable contact 4, which is mounted via a contact spring 40 and is also connected to the shaft 7. The shaft 7 can preferably be made with or of stainless steel. An electrically insulating contact holder 47, which can also be referred to as a bridge insulator, can be arranged between the movable contact 4 and the shaft 7 to electrically insulate the movable contact 4 from the shaft 7.

The magnetic core 6 is surrounded by a coil 8. A current flow in the coil 8, which can be switched on from the outside by a control circuit, causes the magnetic core 6 and thus the entire magnetic armature 5 to move in the axial direction until the movable contact 4 contacts the fixed contacts 2, 3. In the illustration shown, the magnetic armature moves upwards. The magnetic armature 5 thus moves from a first position, which corresponds to the rest state shown and at the same time to the separating, i.e. non-conducting and thus switched-off switching state, to a second position, which corresponds to the active, i.e. conducting and thus switched-on switching state. In the active state, the contacts 2, 3, 4 are galvanically connected to each other.

To guide the shaft 7 and thus the magnetic armature 5 and to form a magnetic circuit with the magnetic core 6 and the coil 8, the switching device 100 further has a yoke 9, which can comprise pure iron or a low-doped iron alloy or be made thereof and which forms part of the magnetic circuit. The yoke 9 has an opening in which the shaft 7 is guided. Furthermore, a sleeve or bushing, for example made of a plastic material, can additionally be arranged in the opening of the yoke 9 to guide the shaft 7. If the current flow in the coil 8 is interrupted, the magnetic armature 5 is moved back to the first position by one or more springs 10, which can also be referred to as return springs. In the illustration shown, the magnetic armature 5 thus moves downwards again. The switching device 100 is then back in its rest state, in which the contacts 2, 3, 4 are open.

The direction of movement of the magnetic armature 5 and thus of the movable contact 4 is also referred to below as the vertical direction 91. Unless otherwise specified, terms such as “up” or “down” refer to the vertical direction 91. The direction of arrangement of the fixed contacts 2, 3, which is perpendicular to the vertical direction 91, is referred to below as the longitudinal direction 92. The direction perpendicular to the vertical direction 91 and perpendicular to the longitudinal direction 92 is referred to below as the transversal direction 93. The directions 91, 92, and 93, which also apply independently of the switching movement described, are indicated in the figures for ease of orientation.

For example, during opening of the contacts 2, 3, 4 at least one electric arc can be generated which can damage the contact surfaces of contacts 2, 3, 4. This can result in the contacts 2, 3, 4 “sticking” together due to welding caused by the electric arc and no longer being able to be separated from one another. The switching device 100 then remains in the switched-on state even though the current in the coil 8 is switched off and the load circuit should therefore be disconnected. In order to prevent the formation of such arcs or at least to assist in extinguishing any arcs that do occur, the contacts 2, 3, 4 are arranged in a gas atmosphere so that the switching device 100 is configured as a gas-filled relay or gas-filled contactor. For this purpose, the contacts 2, 3, 4 are arranged within a switching chamber 11, formed by a switching chamber wall 12 and a switching chamber base 13, in a gas-tight region 14 formed by a hermetically sealed part, wherein the switching chamber 11 can be part of the gas-tight region 14. The gas-tight region 14 is essentially formed by parts of the switching chamber 11, the yoke 9 and additional walls. The gas-tight region 14 completely surrounds the magnetic armature 5 and the contacts 2, 3, 4, except for parts of the fixed contacts 2, 3 which are intended for external connection. The gas-tight region 14 and thus also the interior 15 of the switching chamber 11 are filled with a gas. The gas which can be filled into the gas-tight region 14 through a gas filling nozzle during the manufacture of the switching device 100 can preferably contain hydrogen, for example 20% or more H₂ in an inert gas or even 100% H₂, since hydrogen-containing gas can promote the extinguishing of arcs.

The switching chamber base 13 is arranged above a flange 16 in which the yoke 9 is arranged and which forms part of the magnetic circuit. The flange 16 can be made with or of iron or steel.

Outside the switching chamber 11, additional permanent magnets 17, known as blow magnets, can be provided, which are intended and configured to deflect the arcs. In particular, the blow magnets cause the arc path to be lengthened and can thus improve the extinguishing of the arcs.

The switching chamber wall 12 and the switching chamber base 13 can, for example, be made of or with a metal oxide such as Al₂O₃. Plastics with a sufficiently high temperature resistance, such as PEEK, PE and/or glass fiber-filled PBT, are also suitable. Alternatively or additionally, the switching chamber 11 can also comprise at least partially a POM, in particular with the structure (CH₂O)n. Such a plastic can be characterized by a comparatively low carbon content and a very low tendency for forming graphite. The equal proportions of carbon and oxygen, particularly in (CH₂O)ₙ, can result in the formation of predominantly gaseous CO and H₂ during heat-induced and, in particular, arc-induced decomposition. The additional hydrogen can enhance arc extinguishing.

In conjunction with the following figures, examples of embodiments of the switching device 100 and of components thereof are described which allow detection of the switching states, wherein the switching device 100 according to the following description can be configured as the switching device 100 described in connection with FIG. 1, except for the features described below. For easier recognition of the orientations and sectional planes, the directions 91, 92, 93 are also indicated in the following figures.

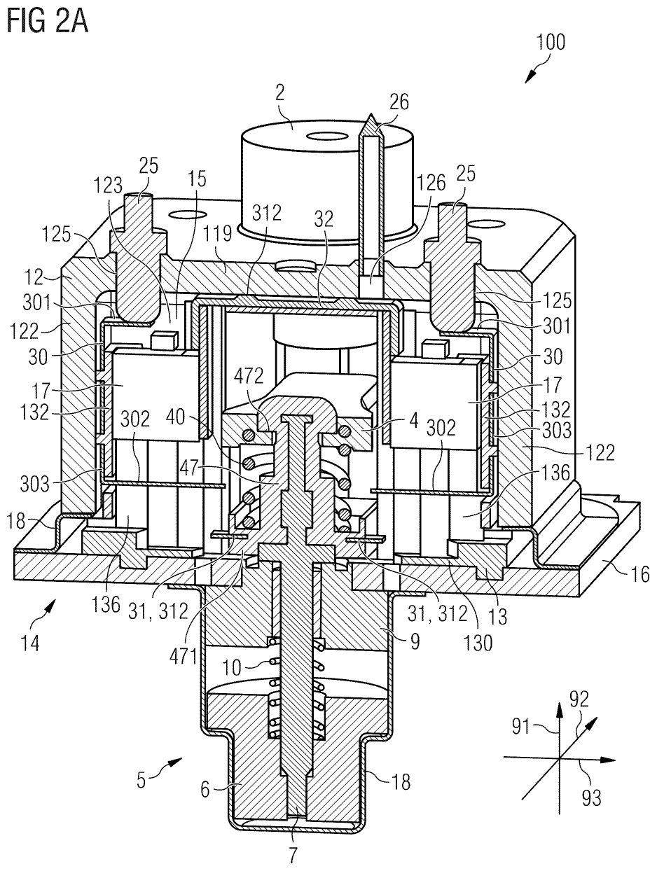

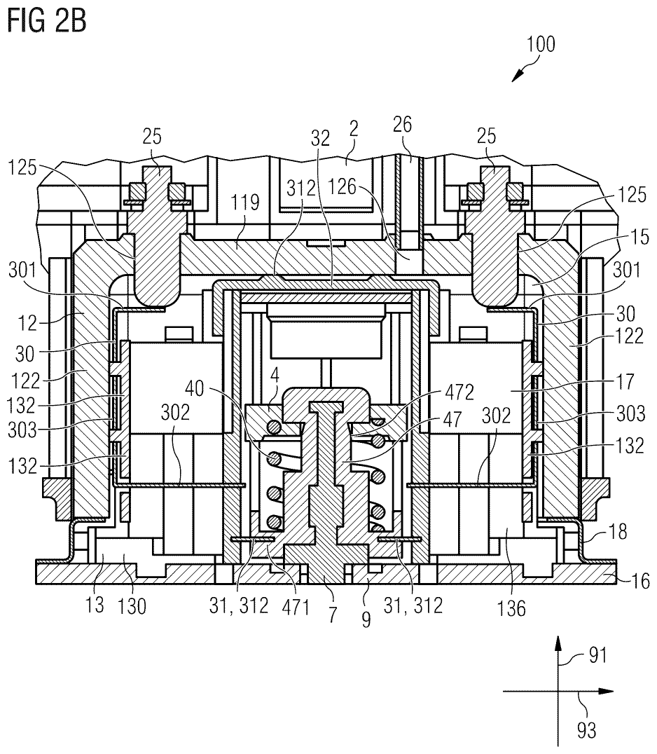

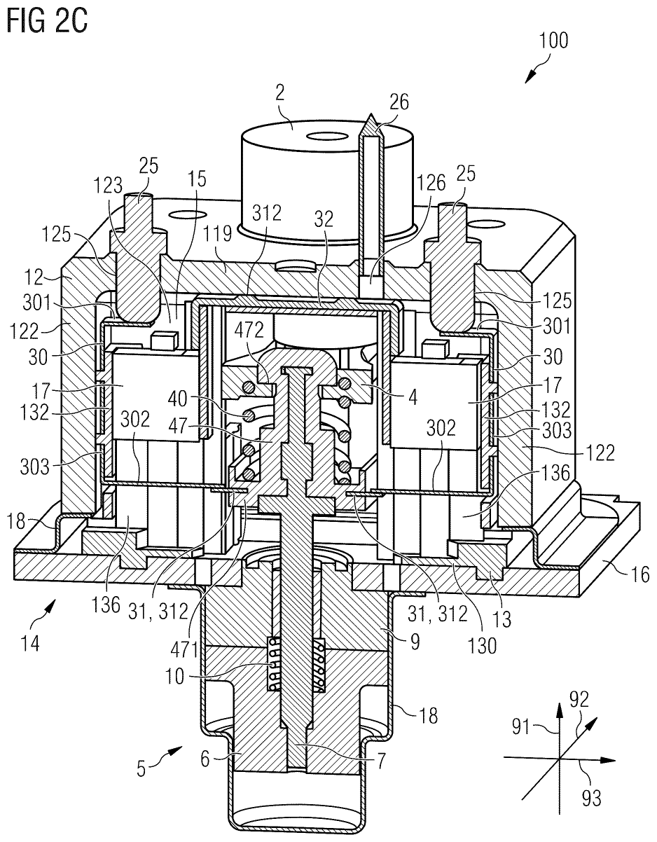

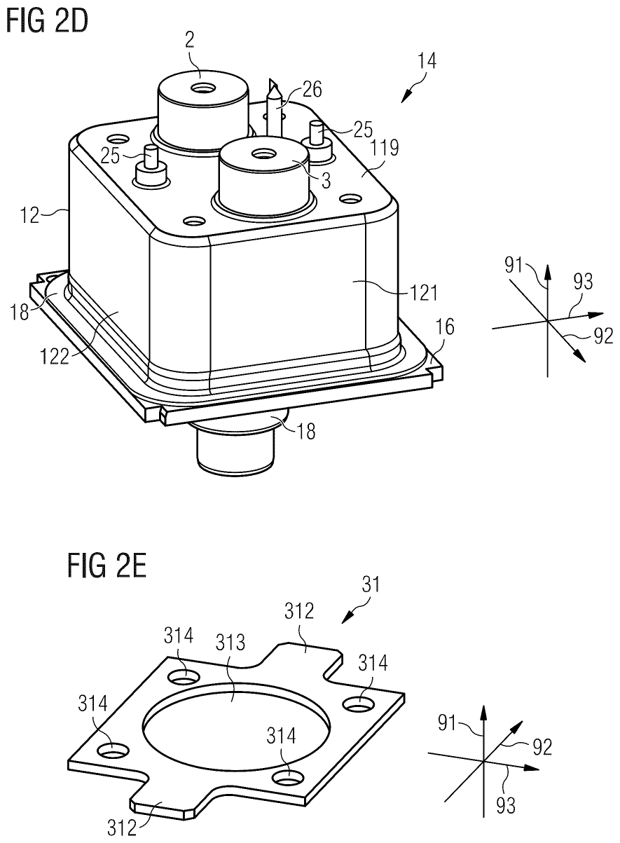

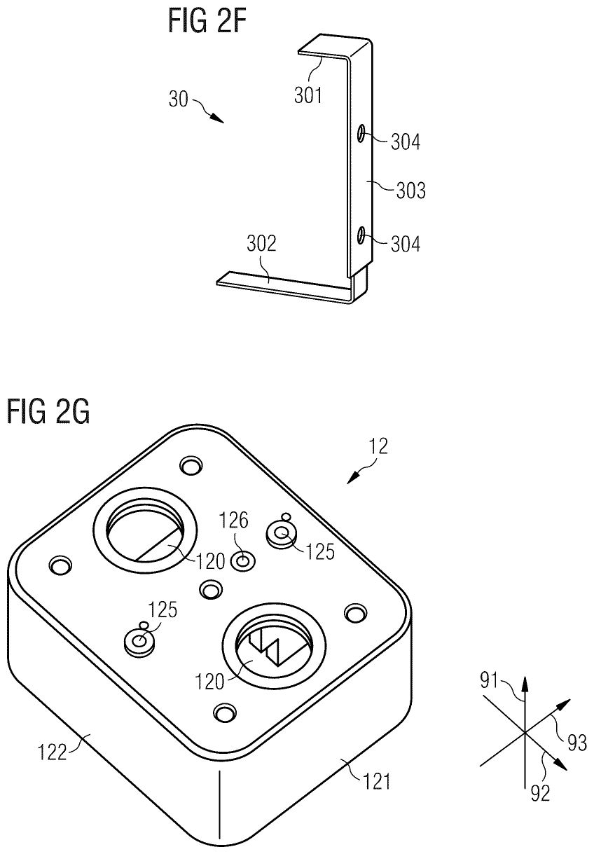

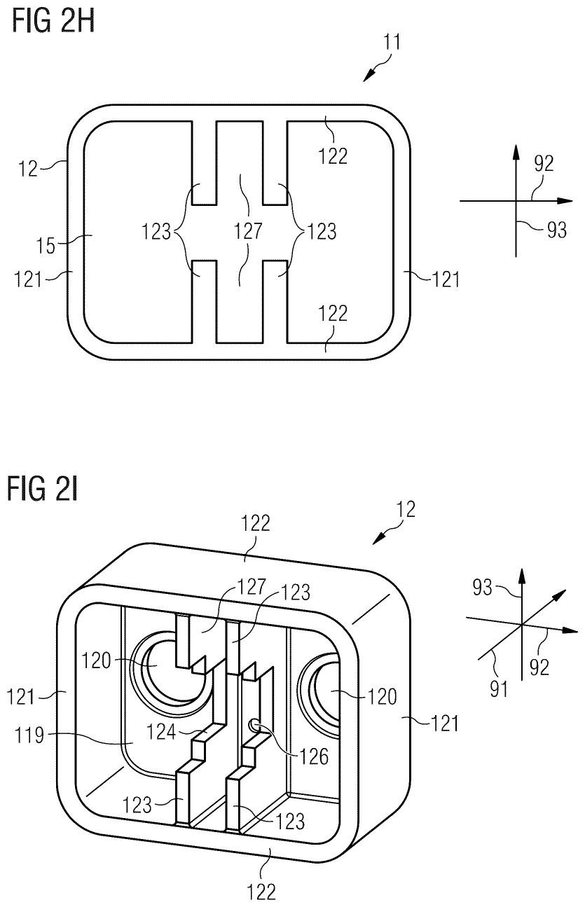

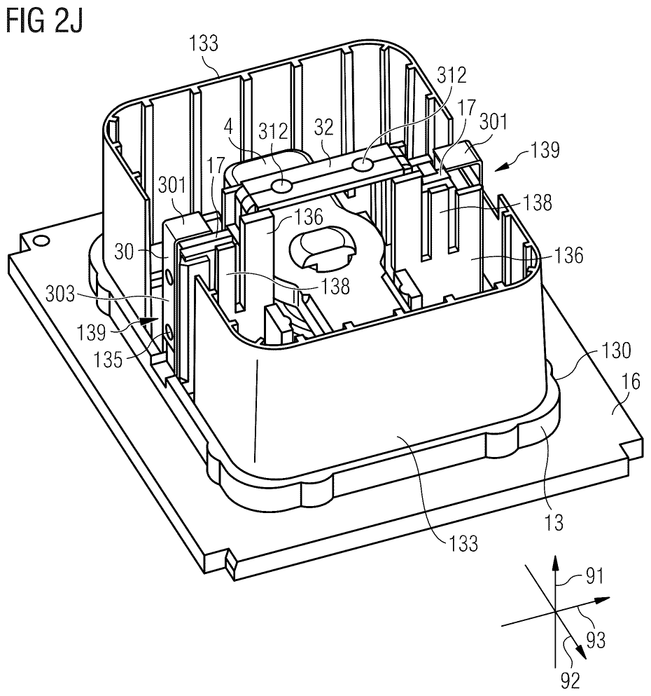

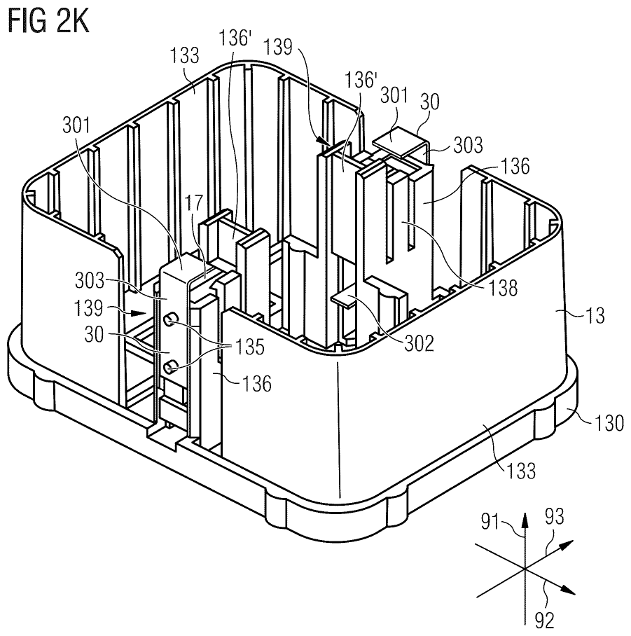

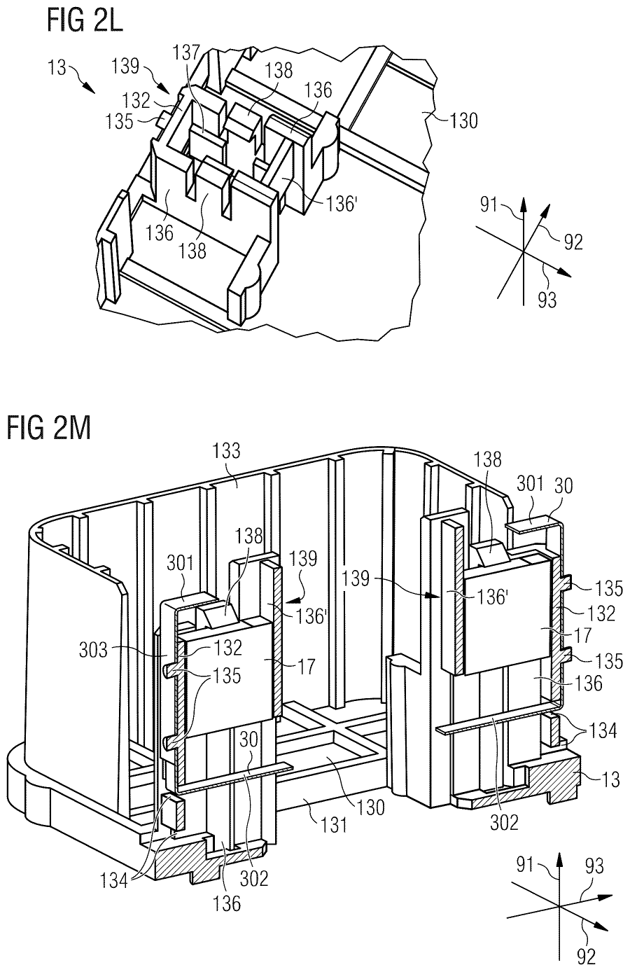

FIGS. 2A and 2B show, by means of a three-dimensional sectional view and a two-dimensional sectional view, sections of the switching device 100 in which essentially the gas-tight region 14 and the region of the switching chamber 11 are shown. The sectional planes of the FIGS. 2A and 2B are each perpendicular to the longitudinal direction 92. FIG. 2C shows a view corresponding to the view of FIG. 2A, wherein in FIG. 2C the switching device 100 is in a different switching state. FIG. 2D shows a three-dimensional external view of the gas-tight region 14. FIGS. 2E and 2F show the contact plate 31 and a spring contact 30. FIGS. 2G to 2M show different views of the switching chamber wall 12 and the switching chamber base 13. The following description refers equally to FIGS. 2A to 2M.

Compared to the switching device of FIG. 1, the switching device 100 according to FIGS. 2A to 2M has two auxiliary contacts 25 which are arranged in openings 125 of the switching chamber wall 12 and which, like the fixed contacts 2, 3, project into the interior 15 of the switching chamber 11.

In the embodiment shown, a further opening 126 is formed between the auxiliary contacts 25 arranged along the transversal direction 93, in which a gas filling nozzle 26 is arranged. The gas filling nozzle 26 can be used to fill the gas atmosphere into the gas-tight region and can be closed after filling, for example by squeezing.

The auxiliary contacts 25 and the gas filling nozzle 26 are preferably soldered into the openings 125, 126 of the switching chamber 11 so that the auxiliary contacts 25 and also the gas filling nozzle 26 are passed through the switching chamber 11 with a hermetically sealed and, for example, brazed connection comparable to the feed-trough of the fixed contacts 2, 3. The contacts 2, 3 and the auxiliary contacts 25 as well as the gas filling nozzle 26 can preferably be assembled in a single work process.

The auxiliary contacts 25 are preferably arranged completely within the housing. Via supply lines (not shown) within the housing, which are electrically connected, for example, to external electrical connections on the housing, the auxiliary contacts 25 can be contacted from the outside. Alternatively, the auxiliary contacts 25 can protrude from the housing like the fixed contacts 2, 3 and can be contactable from outside the housing.

Furthermore, the switching device 100 has two spring contacts 30 and a contact plate 31, which are arranged in the switching chamber 11. In particular, the spring contacts 30 and the contact plate 31 are arranged completely within the interior 15 of the switching chamber 11. Each of the spring contacts 30 extends from one of the auxiliary contacts 25 to the contact plate 31 and, as shown, for example, in FIG. 2F, has a first contact region 301 and a second contact region 302, which are connected to each other via a connection region 303. Each of the spring contacts 30 contacts one of the auxiliary contacts 25 with the first contact region 301. In particular, each of the spring contacts 30 can contact one of the auxiliary contacts 25 permanently and independently of the switching states of the switching device 100 during normal operation with its first contact region 301. The first contact regions 301 of the spring contacts 30 are located, as can be seen, directly and thus mechanically on the auxiliary contacts 25.

The contact plate 31 is movable together with the movable contact 4. For this purpose, the contact plate 31 and the movable contact 4 are together connected to the mechanical drive described above in connection with FIG. 1. In a non-conducting switching state of the switching device 100, i.e. the rest state shown in FIGS. 2A and 2B, the contact plate 31 is spaced apart from the second contact regions 302 of the spring contacts 30. In a switching state in which the fixed contacts 2, 3 are in contact with the movable contact 4 and which is shown in FIG. 2C, the movable contact plate 31 is in mechanical contact with the second contact regions 302. For this purpose, the contact plate 31 has contact regions 312, as shown, for example, in FIG. 2E. The switching state of the switching device 100 according to FIG. 2C is a first switching state of the switching device 100, while the non-switching state of the switching device 100 according to FIGS. 2A and 2B is a second switching state. In the second switching state, there is thus a switching gap between the movable contact 4 and the fixed contacts 2, 3. In the first switching state, the second contact regions 302 of the spring contacts 30 are in mechanical and thus galvanic contact with the contact regions 312 of the contact plate 31, so that the spring contacts 30 and thus also the auxiliary contacts 25 are electrically conductively connected to one another by the contact plate 31. This allows the first and second switching states to be distinguished, for example by measuring the resistance at the auxiliary contacts 25.

The movable contact 4 and the contact plate 31 are arranged on an electrically insulating contact holder 47. The contact holder 47 has an opening into which the shaft 7 is inserted and is fastened to the shaft 7 of the magnetic armature 5 and thus to the mechanical drive of the switching device 100. The contact holder 47 can be configured as a single piece or as multiple pieces.

The movable contact 4 and the contact plate 31 are electrically insulated from the shaft 7 by the contact holder 47. As a result, the movable contact 4 and the contact plate 31 are electrically insulated from the components of the mechanical drive, i.e. in particular from the components of the magnetic armature 5. For this purpose, the contact holder has an electrically insulating material or is made of such a material, which is selected, for example, from polymers and ceramic materials such as polyoxymethylene (POM), in particular with the structure (CH₂O)ₙ, polybutylene terephthalate (PBT), glass fiber-filled PBT, and electrically insulating metal oxides such as Al₂O₃.

The contact plate 31 is fixed to the contact holder 47. The fixing can be carried out, for example, by means of a clamp or, as shown, particularly preferably by molding. For this purpose, the contact plate 31 is partially molded in the material of the contact holder 47, for example by being cast or injection molded. To make contact with the second contact regions 302 of the spring contacts 30, the contact regions 312 of the contact plate 31 protrude from the contact holder 47 in the transversal direction 93.

As shown in FIG. 2E, the contact plate 31 is, for example, disc-shaped and has a central opening 313 through which the shaft 7 protrudes in the assembled state. Furthermore, the contact plate 31 can have anchoring holes 314 through which the material of the contact holder 47 can pass, thereby fixing the contact plate 31 to the contact holder 47 and securing it against rotation, for example.

The contact holder 47 further has a lower stop 471 and an upper stop 472. The contact plate 31 is arranged in the lower stop 471, which can rest on the switching chamber base 13 in the second switching state. The movable contact 4 rests against the upper stop 472 in the second switching state. The contact spring 40 described in FIG. 1 is arranged between the movable contact 4 and the lower stop 471, which presses the movable contact 4 against the upper stop 472 and thus in the direction of the fixed contacts 2, 3.

The magnetic armature 5 with the movable contact 4 is an overtravel system in which the movable contact 4 is arranged so as to be displaceable on the contact holder 47. When the movable contact 4 strikes the fixed contacts 2, 3 and thus when the switching gap is completely closed in the first switching state, the contact spring 40 can compress and the magnetic armature 5 can move further until, for example, the magnetic core 6 rests against the yoke 9. For example, the magnetic armature can move upward in the vertical direction 91 by a distance less than or equal to 1 mm and, particularly preferably, by about 0.5 mm further than the movable contact 4. The compression of the contact spring 40 due to the overtravel increases the contact pressure of the movable contact 4 on the fixed contacts 2, 3, thereby achieving a certain insensitivity to vibrations and mechanical shocks.

As can be seen in particular in FIGS. 2G to 2I, the switching chamber wall 12 has, in a horizontal sectional view, a rectangular cross-sectional shape or at least a cross-sectional shape approximating a rectangle, which can, for example, have rounded corners as shown. The switching chamber wall 12 has opposite transversal side wall parts 121 and opposite longitudinal side wall parts 122, which form the at least approximately rectangular shape. The transversal side wall parts 121, the longitudinal side wall parts 122 and a cover part 119 with openings 120 for the fixed contacts 2, 3 and with the openings 125, 126 for the auxiliary contacts 25 and the gas filling nozzle 26 are, as indicated in the embodiment shown, formed in one piece and form the switching chamber wall 12. The switching chamber wall 12 is particularly preferred to be formed from one of the aforementioned ceramic materials.

As described above, each of the spring contacts 30 has a connection region 303 between the first and second contact regions 301, 302, which, as can be seen in FIGS. 2A to 2C, runs along a longitudinal side wall part 122. The first and second contact regions 301, 302 of each of the spring contacts 30 can preferably extend from the respective longitudinal side wall part 122 at least along the transversal direction 93 into the interior 15 of the switching chamber 11.

The spring contacts 30 and/or the contact plate 31 preferably comprise a material containing copper or a copper alloy. The material can be selected in particular from CuBe, CuSn₄, CuSn₆. Such a material can have good electrical conductivity and a low tendency to weld. The auxiliary contacts 25 can be made of a material described above for the fixed contacts 2, 3 or of a material described for the spring contacts 30 and/or contact plate 31.

The spring contacts 30 are preferably configured in a strip shape, in particular as metal strips, as shown. At least one of the contact regions 301, 302 of each of the spring contacts 30 can be configured to be spring-loaded. For example, the first contact region 301 of each spring contact 30 can be spring-loaded and exert a spring force on an auxiliary contact 25. Thus, the first contact region 301 can press against an auxiliary contact 25 when assembled and thus exert the spring force.

Furthermore, the second spring regions 302 are preferably spring-loaded, either alternatively or additionally. It is particularly preferred that the second contact regions 302 exert a spring force on the contact plate 31 and, in particular, on the contact regions 312 thereof in the first switching state. The spring action of the second contact regions 302 increases the resistance of the mechanical contact between the contact plate 31 and the second contact regions 302 of the spring contacts 30 to vibrations and mechanical shocks. It is particularly preferred that the spring force of the second contact regions 302 on the contact plate 31 and thus the counterforce on the magnetic armature and in particular on the contact holder 47 is less than the restoring spring force of the restoring spring 10 of the mechanical drive, which moves the magnetic armature from the conducting state to the non-conducting state. It is particularly preferred that the spring force of the second contact regions 302 on the contact plate 31 is less than or equal to 20% of the return spring force. When the switching device 100 transitions from the first to the second switching state, the contact plate 31 can lose mechanical contact with the second contact regions 302 of the spring contacts 30 after traveling a distance greater than the overtravel. In other words, the second contact regions 302 remain in mechanical contact with the contact regions 312 of the contact plate 31 as long as the overtravel is not reduced. Only after the overtravel has been eliminated and the magnetic armature 5 and, in particular, the contact holder 47 with the contact plate 31 attached thereto have moved downwards to such an extent that the movable contact 4 has been moved away from the fixed contacts 2, 3 by the magnetic armature 5, do the second contact regions 302 lose mechanical contact with the contact plate 31. This ensures that the contact plate 31 remains in mechanical contact with the spring contacts 30 even if the movable contact 4 is in mechanical contact with at least one fixed contact 2, 3, for example due to unwanted welding. In this case, only the overtravel would be reduced and the movable contact 4 would remain in the conducting state, which could be detected by the auxiliary contacts still short-circuited by the contact plate, even if the mechanical drive of the switching device 100 is already switched off.

The switching device 100 of the embodiment shown in FIGS. 2A to 2M thus enables reliable detection of the “safely closed” state and combines this with a simple mechanism for detecting and outputting the signal from a hermetically sealed switching chamber.

As can be seen in particular in FIGS. 2H and 2I, the switching chamber wall 12 further has at least two webs 123, each of which is arranged in the longitudinal direction 92 between the at least two fixed contacts 2, 3 and each of which extends from at least one longitudinal side wall part 122 in the transversal direction 93 into the switching chamber 11. The webs 123 are spaced apart from one another in the longitudinal direction 92. In particular, the webs 123 extend in the transversal direction 93 across the movable contact 4 in the inner space 15 of the switching chamber 11 from one of the longitudinal side wall parts 122 to the other of the longitudinal side wall parts 122. Furthermore, the webs 123 each have a recess 124 in which the movable contact 4 can move during the switching operations. As shown, the webs 123 can preferably be connected directly to the cover part 119 of the switching chamber wall 12. In particular, the webs 123 can run along and immediately adjacent to the cover part 119 of the switching chamber 11. The webs 123 are particularly preferably formed in one piece with the side wall parts 122 and the cover part 119 of the switching chamber wall 12.

The webs 123 form a region in the interior space 15 between the fixed contacts 2, 3, which region is at least partially separated from and, thus, electrically insulated from the fixed contacts 2, 3. The auxiliary contacts 25, the spring contacts 30 and also the gas filling nozzle 26 are arranged in the insulated space 127 thus formed.

The auxiliary contacts 25 are preferably arranged symmetrically between the two webs 123 with respect to the movable contact 4. Accordingly, the spring contacts 30 are also arranged symmetrically between the two webs 123 with respect to the movable contact 4. Due to the fact that at least one of the webs 123 is formed between each of the auxiliary contacts 25 and the fixed contacts 2, 3 and between each of the spring contacts 30 and the fixed contacts 2, 3, the auxiliary contacts 25 and the spring contacts 30 are at least partially insulated from the fixed contacts 2, 3.

As shown, for example, in FIGS. 2K to 2M, the switching chamber base 13, which is preferably made of POM or another plastic material mentioned above, has a base plate 130 with an opening 131 for the shaft 7 to pass through. At least partially circumferential at the edge of the base plate 130, the switching chamber base 13 has side wall parts 132, 133 which, when the switching chamber 11 is assembled, are inserted into the switching chamber wall 12 along the side wall parts 121, 122 of the switching chamber wall 12. The side wall parts 132, 133 of the switch chamber base are preferably formed in one piece with the base plate 130 of the switch chamber base 13. The side wall parts 132, 133 of the switching chamber base 13 can be surrounded in the assembled switching chamber 11 by the side wall parts 121, 122 of the switching chamber wall 12, so that the side wall parts 132, 133 of the switching chamber base 13 can form an insertion into the switching chamber wall 12. At least one part of the side wall parts 132, 133 of the switching chamber base can be spaced apart from side wall parts of the switching chamber wall. The base plate 130 can serve as a counter stop for the lower stop 471 of the contact holder 47 at least in some regions around the opening 131. For mechanical stabilization, the base plate 130 can have, for example, intersecting webs as shown.

The spring contacts 30 are arranged on side wall parts 132 of the switching chamber base 13, which are opposite each other in the transversal direction 93 and are spaced apart from the longitudinal side wall parts 122 of the switching chamber wall 12. The connection region 303 of each of the spring contacts 30 is arranged in the transversal direction 93, as viewed from the movable contact 4, behind a side wall part 132, so that for each spring contact 30 a side wall part 132 of the switching chamber base 13 is arranged between the movable contact 4 and the connection region 303. The connection region 303 of each of the spring contacts 30 is thus arranged in the transversal direction 93 between a side wall part 122 of the switching chamber wall 12 and a side wall part 132 of the switching chamber base 13.

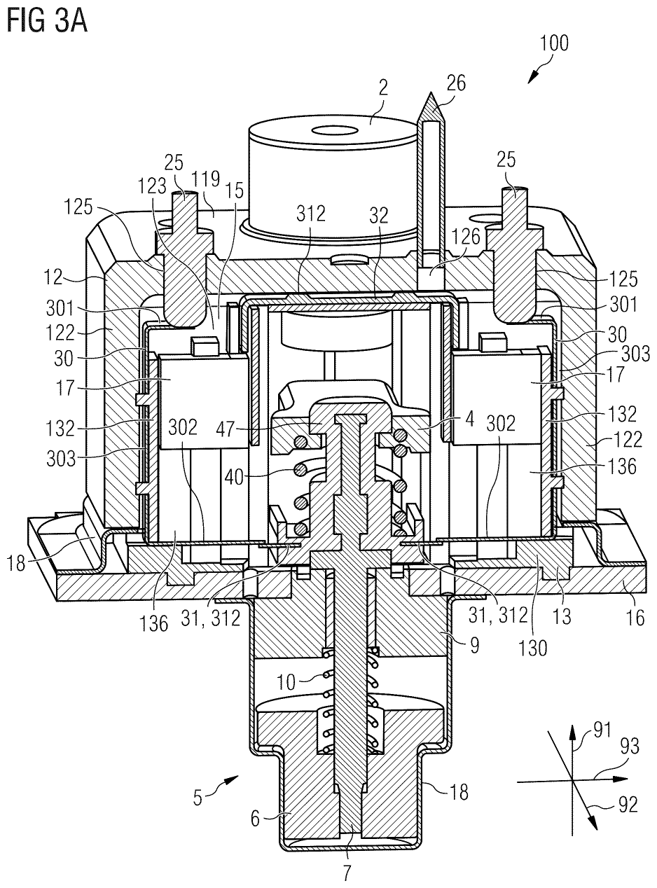

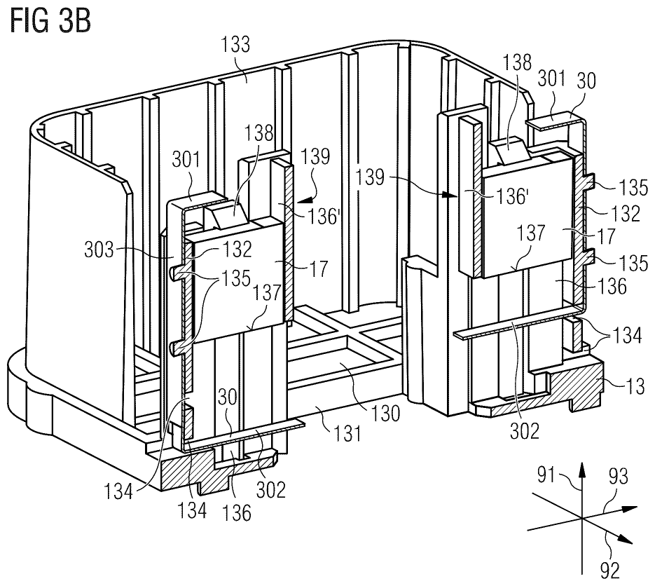

Furthermore, the switching chamber base 13 has an opening 134 for each spring contact 30 in the respective side wall part 132, through which the second contact region 302 of the spring contact 30 protrudes through the side wall 132 of the switching chamber base. This allows the second contact region 302 of each spring contact 30 to protrude towards the movable contact 4 along the transversal direction 93. As can be seen, for example, in FIG. 2M, a further opening 134 can be provided in each of the side wall parts 132, which is arranged at a different height. In particular, the further openings 134 are provided in the region of the base plate 130. This allows the second contact region to be guided at a different height relative to the movable contact 4 and thus also relative to the contact plate 31 when other spring contacts with longer connection regions are used, as described below in connection with FIGS. 3A and 3B.

Furthermore, each of the spring contacts 30 in the connection region 303 has at least one opening 304 through which a fastening element 135 of the respective side wall part 132 of the switching chamber base 13 protrudes. The fastening elements are preferably formed in one piece with the respective side wall part and serve to fasten the respective spring contact. In the embodiment shown, the spring contacts 30 each have two openings 304 and are fastened to the side wall parts 132. For example, the fastening elements 135 can be configured in the form of pins, as shown, and enable a rivet-like fastening.

Furthermore, the switching chamber base 13 has wall parts 136 on both sides of the opening 131, which, when viewed in the longitudinal direction 92, are arranged next to each other between the webs 123 of the switching chamber wall 12 and which, together with the side wall parts 132 on which the spring contacts 30 are located, form insertion regions 139. Permanent magnets 17, in particular blow magnets, are arranged in the insertion regions 139. In particular, each of the permanent magnets 17 can rest on a support surface 138 formed on the wall parts 136 and be secured in the insertion region 139 by a snap mechanism 137, for example formed by barbs. The switching chamber base 13 can thus preferably have two insertion regions 139 between which, when viewed in the transversal direction 93, the movable contact 4 is arranged. The movable contact 4 can preferably move in the vertical direction 91 along the insertion regions 139 during the transition from the first to the second switching state and vice versa. Further wall parts 136′ of the insertion regions 139 can connect the wall parts 136 to one another and be arranged between the permanent magnets 17 and the movable contact 4. Openings are provided below the further wall parts 136′ between the wall parts 136, into which the contact regions 312 of the contact plate 31 can move.

As shown, for example, in FIG. 2J, a clamp element 32 can be placed over the contact bridge 4, adjacent to the further wall parts 136′ of the insertion regions 139, which can be made of the same material as the switching chamber base 13. The clamping element 32, which can be kept away from the cover part 119 by spacers 321, which can be of a knob-like design, can, for example, shield the gas filling nozzle 26 from the contacts 2, 3, 4 so that no arcs can form in the region of the gas filling nozzle 26.

FIGS. 3A and 3B show, according to a further embodiment, sections of the switching device 100 corresponding to the views in FIGS. 2A and 2M, in which the spring contacts 30 are longer so that the second contact regions 302 of the spring contacts 30 pass through the lower openings 134 in the side wall parts 132 described above. As a result, the switching device 100 is in the first switching state, in which the contact plate 31 mechanically contacts the spring contacts 30, in the non-conducting switching state, i.e. in the rest state, as can be seen in FIG. 3A. In the second switching state, in which the contact plate 31 is spaced apart from the spring contacts 30, the switching device 100 is in the switching state. Thus, in the embodiment shown in FIGS. 3A and 3B, the rest state of the switching device 100 can be detected by the fact that the auxiliary contacts 25 are short-circuited by the spring contacts 30 and the contact plate 31. Thus, the embodiment shown in FIGS. 3A and 3B has a reverse switching state detection characteristic compared to the embodiment shown in FIGS. 2A to 2M, which can be achieved solely by using different spring contacts 30. Thus, the switching device 100 can be provided with the desired switching state detection characteristic in a simple manner and without any other structural changes, depending on the customer's requirements.

The second contact regions 302 of the spring contacts 30 are preferably configured such that, when the switching device 100 transitions from the first to the second switching state, the contact plate 31 loses mechanical contact with the second contact regions 302 of the spring contacts 30 after traveling a distance that is less than or equal to 20% of the switching gap. This ensures that the distance that the magnetic armature 5 must travel on its way from the first to the second switching state before the contact between the contact plate 31 and the spring contacts 30 breaks is very small. The second contact regions 302 of the spring contacts 30 are particularly preferably configured and, for example, slightly bent upwards such that, upon contact with the contact regions 312 of the contact plate 31 when the magnetic armature 5 and thus also the contact plate 31 are moved downwards to the lower stop of the magnetic armature 5, they are pressed down by approximately 0.5 mm and, correspondingly, lose contact with the contact plate 31 when the magnetic armature 5 and thus the contact plate 31 are moved upwards after the corresponding distance.

In case the movable contact 4 remains in the conducting state due to sticking or a mechanical defect, even though the mechanical drive has been switched off and the switching device 100 should return to the first switching state, the contact plate 31 remains spaced apart from the second contact regions 302 of the spring contacts 30, so that the first switching state is not read at the auxiliary contacts 25. This is also possible taking into account the overtravel, since the magnetic armature 5 falls downwards towards the switching chamber base 13 by a certain amount in comparison with the movable contact 4, although the contact plate 31 is positioned in such a way that the distance between the contact plate 31 and the second contact regions 302 of the spring contacts 30 is still large enough to clearly prevent an electrically conductive connection between the auxiliary contacts 25. Mechanical influence due to shocks follows the properties of the mechanical drive and the movable contact 4. This means that the electrical contact of the auxiliary contacts 25 with each other would correctly indicate incomplete opening even after the movable contact 4 has been lifted from the fixed contacts 2, 3 by acceleration. The switching device 100 of the embodiment shown in FIGS. 3A and 3B thus enables reliable detection of the “safely open” state and combines this with a simple mechanism for detecting and outputting the signal from a hermetically sealed switching chamber.

The configuration based on standard IEC 60947-5-1 also allows detection of the “switching device cannot close” state, i.e., the state in which the movable system is blocked in the open position. Even if the upper part of the switching device is destroyed, it is still possible to detect whether the switching device has been set to the non-conducting state.

An advantage of the switching device 100 described here is its very low-cost manufacture, as no wiring and no integrated circuits are required. Furthermore, no magnetic influence on the detection is possible. In addition, the detection of the switching states in both configuration variants takes place sufficiently far away from the main contacts, i.e., sufficiently far away from the fixed contacts and the movable contact, so that no problems arise with regard to insulation or the risk of destruction by switching arcs.

The features and embodiments described in connection with the figures can be combined with one another in accordance with further embodiments, even if not all combinations are explicitly described. Furthermore, the embodiments described in connection with the figures can alternatively or additionally have further features in accordance with the description in the general part.

The invention is not limited to the description based on the embodiments. Rather, the invention encompasses every new feature and every combination of features, including in particular every combination of features in the patent claims, even if this feature or combination is not explicitly stated in the patent claims or embodiments.

1.-17. (canceled)

18. A switching device comprising:
a movable contact in a switching chamber; and
at least two auxiliary contacts, two spring contacts and a contact plate in the switching chamber,
wherein the switching chamber has side wall parts,
wherein each of the spring contacts comprises a first contact region and a second contact region,
wherein the first contact region and the second contact region are connected via a connection region,
wherein a side wall part is arranged between the connection region of each of the spring contacts and the movable contact, and
wherein the contact plate is movable together with the movable contact.

19. The switching device according to claim 18, wherein the switching chamber comprises a switching chamber base with a base plate and the side wall parts.

20. The switching device according to claim 19,
wherein the switching chamber comprises a switching chamber wall with opposing transversal side wall parts and with opposing longitudinal side wall parts, and
wherein the connection region of each of the spring contacts extends between a longitudinal side wall part and the side wall part of the switching chamber base.

21. The switching device according to claim 19,
wherein the switching chamber base comprises an insertion region between each of the spring contacts and the movable contact, and
wherein a permanent magnet is arranged in the insertion region.

22. The switching device according to claim 21, wherein each of the insertion regions comprises a snap mechanism securing the respective permanent magnet.

23. The switching device according to claim 21, further comprising:
at least two fixed contacts,
wherein the switching chamber has at least two webs, which are arranged along a longitudinal direction between the at least two fixed contacts, and each web extends from at least one longitudinal side wall part in a transversal direction into the switching chamber, and
wherein the insertion regions are arranged between the webs.

24. The switching device according to claim 18, wherein each of the spring contacts comprises at least one opening in the connection region through which a fastening element of the respective side wall part of a switching chamber base protrudes.

25. The switching device according to claim 18, wherein each of the side wall parts comprises an opening between the connection region of one of the spring contacts and the movable contact through which the respective second contact region protrudes.

26. The switching device according to claim 25, wherein the respective second contact region protrudes through the respective opening in a direction of the contact plate.

27. The switching device according to claim 18, further comprising at least two fixed contacts, which are arranged next to each other along a longitudinal direction, wherein the auxiliary contacts are arranged next to each other along a transversal direction.

28. The switching device according to claim 18, further comprising:
a mechanical drive configured for moving the movable contact and the contact plate, which has a magnetic armature with a shaft on which the movable contact and the contact plate are arranged, and
wherein the auxiliary contacts, the spring contacts and the contact plate are arranged electrically insulated from fixed contacts, the movable contact and the mechanical drive.

29. The switching device according to claim 18, wherein the movable contact and the contact plate are arranged on an electrically insulating contact holder.

30. The switching device according to claim 29,
wherein the contact plate is fixed to the contact holder, and
wherein the movable contact is arranged slidably shiftable on the contact holder.

31. The switching device according to claim 18, wherein the second contact regions are configured to exert a spring force on the contact plate in a first switching state.

32. The switching device according to claim 31, further comprising:
a contact spring arranged on a contact holder,
wherein the contact spring is configured to exert a spring force on the movable contact in a direction of the fixed contacts, and
wherein the spring force of the second contact regions is lower than the spring force of the contact spring.

33. The switching device according to claim 18,
wherein, in a first switching state of the switching device, the contact plate contacts the second contact regions of the spring contacts and, in a second switching state, the contact plate is spaced apart from the second contact regions of the spring contacts, and
wherein the movable contact is separated from the fixed contacts by a switching gap in the first switching state or second switching state, and
wherein the contact plate loses mechanical contact with the second contact regions of the spring contacts after traveling a distance that is less than or equal to 20% of the switching gap when the switching device transitions from the first switching state to the second switching state.

34. The switching device according to claim 18, wherein each of the first contact regions of the spring contacts is configured to exert a spring force on one of the auxiliary contacts.
